(19) United States
(12) Patent Application Publication
(10) Pub. No.: US 2014/0161352 A1
(43) Pub. Date: Jun. 12, 2014

(54) ITERATIVE METHOD FOR DETERMINING A TWO-DIMENSIONAL OR THREE-DIMENSIONAL IMAGE ON THE BASIS OF SIGNALS ARISING FROM X-RAY TOMOGRAPHY

(71) Applicant: COMMISSARIAT A L'ENERGIE ATOMIQUE ET AUX ENERGIES ALTERNATIVES, Paris (FR)

(72) Inventors: Fanny BUYENS, Saint Germain La Grange (FR); Michele QUINTO, Les Ulis (FR)

(21) Appl. No.: 14/065,193

(22) Filed: Oct. 28, 2013

(30) Foreign Application Priority Data
Dec. 7, 2012 (FR) 12 61751

(51) Int. Cl. G06T 7/00

(52) U.S. Cl. CPC G06T 7/0051; G06T 7/0079
USPC 382/173

(57) ABSTRACT

An iterative method for determining a two—or—three-dimensional image on the basis of signals arising from X-ray tomography, comprises: segmenting the image by separating distinct materials respectively by level lines for 2D or level surfaces for 3D; and adapting the mesh, triangular for 2D or tetrahedral 3D, in which points are distributed in a homogeneous manner respectively over a level line for 2D or over a level surface for 3D, serving to formulate the progressively coarse triangular mesh for 2D or tetrahedral mesh for 3D, so that the number of distributed points depends respectively, for a line, on the ratio of the length of the line to the length of the minimum line from among the lines of the segmented image, or, for a surface, on the ratio of the area of the surface to the area of the minimum surface from among the surfaces of the segmented image.

### CROSS-REFERENCE TO RELATED APPLICATION

This application claims priority to foreign French patent application No. FR 1261751, filed on Dec. 7, 2012, the disclosure of which is incorporated by reference in its entirety.

### FIELD OF THE INVENTION

The invention pertains to an iterative method for determining two-dimensional or three-dimensional images on the basis of signals arising from X-ray tomography.

### BACKGROUND

The reconstruction of images by tomography on the basis of projection data is very widespread in the field of medical imaging. By using a sufficiently large number of projection, the filtered backprojection algorithms, or FBP algorithms, make it possible to obtain fast and accurate image reconstructions.

However, in the case of a small number of views (low-dose imaging) and/or of limited angle (specific constraints related to installation), the data available for inversion are not complete, the poor conditioning of the problem is accentuated, and the results show significant artefacts. To tackle these situations, an alternative approach consists in discretizing the reconstruction problem, and in using iterative algorithms (ART the acronym standing for “Algebraic Reconstruction Technique”, SIRT the acronym standing for “Simultaneous Iterative Reconstruction Technique”, and their variants) or a statistical formulation of the problem so as to calculate an estimation of the unknown object. This estimation makes it possible to incorporate a priori information relating to the object and to calculate the MAP (for maximum a posteriori) or regularized likelihood solutions. The introduction of a priori avoids the divergences that are sometimes observed in the non-regularized procedures (for example MLEM the acronym standing for “Maximum Likelihood Expectation-Minimization” and its variants whose number of iterations must be defined by the user to halt the estimation process), but the use of quadratic criteria shows the major drawback of smoothing the contours (gradients) of the reconstructed object. Solutions using non-quadratic functions have formed the subject of numerous studies (“Reconstruction d'images: régularisation avec prise en compte des discontinuités” [Image reconstruction: regularization with regard for discontinuities] by P. Charbonnier, Thesis, University of Nice-Sophia Antipolis, France 1994). It has also been proposed to introduce, in one context, binary Markov variables (“Stochastic relaxation, Gibbs distributions and the Bayesian restoration of images” by Geman S, Geman D, IEEE Trans. Im. Proc. 1984; 6(6):721-741) or continuous variables (“Constrained restoration and the recovery of discontinuities” by Geman D and Reynolds G, IEEE Trans, on Pattern Analysis and Machine Intelligence 1992, 14(3):367-383; “Nonlinear image recovery with half-quadratic regularization and FFT's” by Geman D and Yang C, IEEE Trans, Im Proc 1995, 4(7):932-946).

All these procedures are conventionally based on discretizing the volume into a set of voxels, and provide three-dimensional maps of the density of the object under study. The calculation times and the memory resource of these iterative procedures are the main weak points which render unusual. Moreover, whatever the application (medical or industrial), the common approach consists in applying image processing tools to the reconstructed volumes so as to segment the regions of interest for a quantitative analysis. However, numerous studies have been conducted in the course of the last two decades leading to a wide gamut of segmentation tools, based on various interpretations of the contours and of functionals to be minimized. There are therefore multiple choices and the results may depend thereon.

Within this context, procedures have been proposed for conducting the segmentation and the reconstruction of the object under study in a simultaneous manner. Shape-based approaches model the shape and reconstruct objects by alternately optimizing the position of the boundaries and the parameters describing the intensity distribution. More recently, nonparametric models, such as active contours, developed and used currently in the field of image segmentation, have been implemented.

Diverse documents (“Polygonal and polyhedral contour reconstruction in comuted tomography” by Soussen C, Mohammad-Djafari A, IEEE Trans, Image Proc, 2004 November, 13(11)) have placed the stress on the reconstruction of a three-dimensional or 3D binary image composed of a compact uniform object totally included in a uniform background. The scene is reconstructed with the aid of parametric surface models (splines) whose parameters are estimated on the basis of the data. The results obtained with this polyhedral approach remain strongly related to the initialization, for which the authors propose the use of a harmonic surfaces global procedure. Other documents (“Reconstruction 3D de vaisseaux à partir d'un faible nombre de projections à l'aide de contours déformables” [3D reconstruction of vessels on the basis of a small number of projections with the aid of deformable contours] by Senasli M, Garnero L, Herment A, Mousseaux E, GRETSI, 1997; “3D reconstruction of vessel lumens from very few angiograms by dynamic contours using a stochastic approach” by M. Senasli LGAHEM, Graphical Models, 2000, 62:105-127) have proposed the use of an active contour based on a stochastic process for the reconstruction of binary tomographic images within the framework of reduced data. Spline functions are used to describe the contours of the vessels. In this context of procedures based on the shape of the object for tomographic reconstruction, it has been proposed (“Introducing shape priors in object-based tomography reconstruction” by Gaullier G, Charbonnier P, Heitz F, ICIP, 2009) to introduce an a priori on the shape, whose descriptor based on the Legendre moments is compact and hierarchical. This a priori leads to rendering the constraint on the length of the curve appropriate to the object to be reconstructed. Other authors propose (“3D reconstruction of a patient-specific surface model of the proximal femur from calibrated x-ray radiographs: A validation study” by Zheng G, Schumann S, Med Phys, 2009, 36(4):1155-1166) to use a statistical surface model of the object and a registration model to reconstruct a 3D surface model specific to the patient, on the basis of a pair of calibrated 2D X-ray radiographs. The technique is based on an iterative procedure of non-rigid registration of the characteristic shapes extracted from the statistical model of 3D surfaces with the radiography data.

Segmentation procedures based on level sets were firstly introduced into the field of image processing to capture the moving fronts of surfaces and for shape reconstruction within the framework of inverse problems. They were thereafter applied for simultaneously estimating the values in the reconstructed shapes, and have shown promising results for their use in tomographic reconstruction problems (“Reconstruction absorption and diffusion shape profiles in optical tomography by a level set technique” by Schweiger M, Arridge S, Dorn O, Zacharopoulos A, Kolehmainen V, Optics letters, 2006, 31(4):471-473; “3-D shape and contrast reconstruction in optical tomography with level sets” by Schweiger M, Dorn O, Arridge S, In: IPIA, 2008; “A curve evolution approach to object-based tomographic reconstruction” by Feng H, Karl W, Castañ on D, IEEE tras Im Proc 2003, 12(1):44-57; “Tomographic reconstruction of piecewise smooth images” by Alvino C, Yezzi J A, In: CVPR, 2004; “Level set reconstruction for sparse angularity sampled data” by Yoon S, Pineda A, Fahrig R, In: IEEE NSS Conf Rec, 2006; “level-set approach for the inversion and segmentation of x-ray tomography data” by Ramlau R, Ring W. A Mumford-Shah, J Comput Phys, 2007, 221(2):539-557; “Dynamic cone-beam reconstruction using a variational level set formulation” by Keil A, Vogel J, Lauritsch G, Navab N, In: MICCAI, 2009). Some of these documents have applied the level sets procedure to reconstruct the object on the basis of noisy limited views by electromagnetic tomography. The document “Tomographic reconstruction using curve evolution” by Feng H, Castañ on D, Karl W, IEEE, 2000, uses a level sets method with a small number of texture coefficients to reconstruct the images in a context of limited views in tomography.

Other documents (“Level set reconstruction for sparse angularity sampled data” by Yoon S, Pineda A, Fahrig R, In: IEEE NSS Conf Rec, 2006; “Simultaneous segmentation and reconstruction: A level set method approach for limited view computed tomography” by Yoon S, Pineda A, Fahrig R, Med. Phys. 2010 May, 37(5)) have proposed an iterative algorithm for tomographic reconstruction which simultaneously segments and reconstructs the image domain. The segmentation and the reconstruction are carried out by alternating a segmentation step which causes the evolution of a two-phase level-line function and a reconstruction step which calculates an estimation of the intensity values of the unknown object with the aid of a conjugate gradient algorithm. The piecewise two-phase model has its limits: it can provide sufficient information when we are interested in just one material (single-material object or when the other structures of the object are of lesser interest). An extension of the procedure is necessary when the object is composed of several materials (for example by adding a second level-line function).

Another energy functional, such as the elastic energy in relation to an edge detector, and various geometric models have been envisaged through parametric curves such as “snakes” or the techniques of level sets. The idea of segmenting and reconstructing simultaneously on the basis of data measured by X-ray tomography was proposed in 2007 (“An Active Contour Approach for a Mumford-Shah Model in X-Ray Tomography” by Hoetzl E, Ring W, Advances in Visual Computing, 2009, LNCS 5876:1021-1030). The work is based on the observation that segmentation procedures often fail when the image is very noisy. In the proposed procedure, the segmented contour and the corresponding density are estimated by minimizing the Mumford-Shah functional directly on the basis of the measured data.

All the procedures cited above use a standard representation of the image which consists in dividing the reconstruction volume into a regular grid of pixels in two dimensions (or voxels in three dimensions) and presupposing that the reconstructed medium is constant inside each element of the grid. Other types of representation have been proposed in order to improve the common representation.

The Bessel-Kaiser functions, also called blob, were introduced in 1992 (“Alternatives to voxels for image representation in iterative reconstruction algorithms” by Lewitt R, Phys Med Biol 1992, 37:705-716) as an alternative representation of an image. A family of spherical volume elements is described, two parameters of which control the smoothing of the image (unlike conventional pixels which are discontinuous). Moreover, the symmetry of these spherical elements leads to efficient calculation of the projections. This approach increases the accuracy with respect to the standard approach of image representation based on voxels.

A procedure for reconstructing 2D images based on an irregular discretization has been proposed (“Tomographic image reconstruction based on a content-adaptive mesh model” by Brankov J, Yang Y, Wernick M, IEEE Trans. Med. Imaging. 2004 February, 23(2)) within the framework of Single-Photon Emission Computed Tomography SPECT. The mesh model is based on a non-uniform sampling, the node density of which is directly dependent on the details of the object. The generation of the mesh is based on a reference image obtained by using a FDK (Feldkamp-Kress-Davis) reconstruction on the basis of which the vertices or nodes of the mesh are placed with the aid of a step of extracting a map of characteristics which is carried out on the regular grid of pixels of the reference image. The number of nodes of the mesh is determined by a minimum description length (MDL) criterion, which codes a reference image with the minimum number of bits. The conventional iterative algorithms such as Maximum Likelihood Expectation-Minimization (MLEM) and maximum a posteriori (MAP), have been adapted to triangular meshes and used for image reconstruction. These authors demonstrate that a model of adaptive content meshing of the image provides accurate discretization of the problem with fewer unknowns than by using grids of regular pixels, and can therefore improve the calculation time and the image quality since the density of the mesh is adapted to the details of the image.

A method which explores the deformation of a triangular mesh by direct estimation of the displacements of the vertices of the triangles within the framework of the Bayesian approach (“Tomographic reconstruction using 3D deformable models” by Battle X, Cunnigham G, Hanson K, Phys. Med. Biol. 1998, 43:983-990) has been disclosed. The procedure is applied to SPECT data. The objects are represented by a closed surface, finely divided into triangles enclosing a uniform region (uniform activity). This approach turns out to be simple and efficient, but raises complex questions for the reconstruction of more than one region.

Another deformable model which renders independent the triangulated surfaces and the way in which it is deformed (“Three-Dimensional Attenuation Map Reconstruction Using Geometrical Models and Free-Form Deformations” by Battle X, Le Rest C, Turzo A, Bizais Y, IEEE Trans. Med. Imaging, 2000, 19(5)) has also been proposed. They have proposed an iterative-model based procedure where the unknown map is modelled as a set of geometric regions having a uniform attenuation coefficient. The reconstruction consists in deforming the space so as to best correspond to the measurements. The influence of the choice of the model of the projection matrix and the very long convergence time of the algorithm are the two main weaknesses of the approach.

A 3D tomographic reconstruction procedure using a representation of the volume by a cloud of points and represented by non-overlapping tetrahedrons (“Tomographic reconstruction using an adaptive tetrahedral mesh defined by a point cloud” by Sitek A, Huesman R, Gullberg G, IEEE Trans. Med. Imaging., 2006 September, 25(9)) has been proposed. The density of the nodes defines the local resolution of the image, and the intensity of any point inside the volume is estimated by a linear interpolation between the values of the four nodes which define each tetrahedron. Although the mode of calculation of the matrix system is unwieldy and complex, this representation of the image is better adapted for volume visualization with the aid of known graphical processors, or GPUs the acronym standing for “graphics processing units”.

The main problems raised by the procedures cited hereinabove are as follows:
The two-phase piecewise smoothing model is correct in the case of an object composed of a single material (or in the case of an object for which certain structures are not essential), but the procedure reaches its limits as soon as the object under study is composed of several materials. The assumptions are then in fact no longer satisfied, and the reconstructed images comprise artefacts.
The representation of the image customarily used (regular grids of pixels) induces the estimation of a large number of unknowns, thereby giving rise to a consequent calculation and storage memory cost, especially in the case of high-resolution reconstructions.

### SUMMARY OF THE INVENTION

An aim of the invention is to alleviate the problems cited above, by reducing the number of unknowns to be estimated and by allowing the study of an object composed of several materials or regions of interest.

Hence, there is proposed, according to one aspect of the invention, an iterative method for determining a two-dimensional or three-dimensional image on the basis of signals arising from X-ray tomography, comprising three steps which alternate in an iterative manner until convergence:
a step of estimating the object by an iterative reconstruction algorithm adapted to a representation of the image on an irregular grid of triangles in two dimensions, of tetrahedrons in three dimensions,
a step of segmenting the image by separating distinct materials respectively by level lines for a two-dimensional image or by level surfaces for a three-dimensional image, and
a step of adapting the mesh, respectively triangular for a two-dimensional image or tetrahedral for a three-dimensional image, in which points are distributed respectively over a level line for a two-dimensional image or over a level surface for a three-dimensional image, serving to formulate the mesh, respectively triangular for a two-dimensional image or tetrahedral for a three-dimensional image, so that the number of distributed points depends respectively, for a line, on the ratio of the length of the said line to the length of the minimum line from among the lines of the segmented image, or, for a surface, on the ratio of the area of the said surface to the area of the minimum surface from among the surfaces of the segmented image.

Such a method makes it possible to drastically limit the quantity of calculations and therefore the calculation time required for image determination or reconstruction by X-ray tomography, and offers as result a conventional grey levels (attenuation coefficients) tomographic reconstruction image associated with a mesh containing the segmentation of the various materials or regions of interest of the object under study.

Furthermore, the use of a mesh adapted to the content of the object under study makes it possible to reduce the number of unknowns, and to limit the memory space required.

In one embodiment, the number of points constraining the adaptation of the said mesh is respectively proportional, for a line (two-dimensional segmented contour), to the ratio of the length of the said line to the minimum length of the said lines (segmented contours), or, for a surface, to the ratio of the area of the said surface to the minimum area of the said surfaces.

Thus, each contour, respectively surface, is represented by an appropriate number of points distributed homogeneously over each of the said contours, respectively of the said surfaces, making it possible to generate a fine mesh constrained by these said points at the level of the contours respectively of the said surfaces, which becomes progressively coarser as one moves further away therefrom.

According to one embodiment, the said segmentation step uses an approximation of the image on the basis of a piecewise constant function.

Thus, each material or region of interest represented by a given attenuation coefficient can be segmented by a level set procedure.

In one embodiment, the said approximation uses the following minimization:

$${min}_{{c}_{1} , {c}_{2} , C} \{ {L}_{C} + μ {\int }_{{Ω}^{-}} {( {c}_{1} - f )}^{2} + μ {\int }_{{Ω}^{+}} {( {c}_{2} - f )}^{2} \}$$

in which:
C represents a curve for a two-dimensional image or a surface for a three-dimensional image, which represents the boundary between two constant regions (C=∂Ω);
c₁ and c₂ represent respectively the mean values of the piecewise constant regions for the interior Ω⁻ and for the exterior Ω⁻ of C;
L_{C} represents a regularization term making it possible to control the length of the curve C; and
μ represents a regularization term which controls the segmentation detail.

Thus, through the union of these curves in two dimensions or surfaces in three dimensions, the set of boundaries over which the said mesh points will be distributed is obtained.

According to one embodiment, the method comprises, furthermore, a step of initializing the mesh, with a mesh of constant elementary mesh cell complying with the Delaunay criterion.

### BRIEF DESCRIPTION OF THE DRAWINGS

The invention will be better understood on studying a few embodiments described by way of wholly non-limiting examples and illustrated by the appended drawings in which:

FIGS. 1 and 2 and 3 schematically illustrate the method according to one or more aspects of the invention;

FIGS. 4a and 4b illustrate an exemplary implementation of the single-material 2D method, according to one aspect of the invention; and

FIGS. 5a and 5b illustrate an exemplary implementation of the multi-material 2D method, according to one aspect of the invention.

### DETAILED DESCRIPTION

In all the figures, the elements having the same references are similar.

In FIG. 1 is schematically illustrated an iterative method for determining a two-dimensional or three-dimensional image on the basis of signals arising from X-ray tomography according to one aspect of the invention, comprising:
a step 1 of segmenting the image by separating distinct materials respectively by level lines for a two-dimensional image or by level surfaces for a three-dimensional image, and
a step 2 of adapting the mesh, respectively triangular for a two-dimensional image or tetrahedral for a three-dimensional image, in which points are distributed in an equidistant manner respectively over a level line for a two-dimensional image or over a level surface for a three-dimensional image, serving to formulate the constrained mesh, respectively triangular for a two-dimensional image or tetrahedral for a three-dimensional image, so that the number of distributed points depends respectively, for a line, on the ratio of the length of the said line to the length of the minimum line from among the lines of the segmented image, or, for a surface, on the ratio of the area of the said surface to the area of the minimum surface from among the surfaces of the segmented image.

The use of a mesh adapted to the object under study makes it possible to reduce the number of unknowns, so as to better represent the object while limiting the storage memory space required.

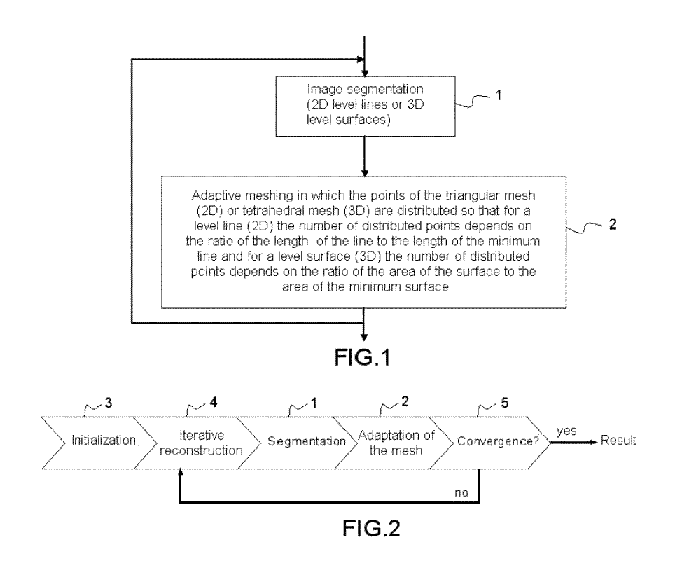

FIG. 2 illustrates a more detailed example of the steps of the method according to one aspect of the invention.

An initialization step 3 consists in meshing the determination or reconstruction domain respectively with elements of triangle type in two dimensions or 2D and by elements of tetrahedron type in three dimensions or 3D, while complying with the constrained Delaunay conditions.

The initial mesh can be a simple mesh comprising N elements and satisfying the following relation: Ndet/100≦N≦Ndet/10, in which Ndet is the number of detector pixels along the largest dimension of the detector.

The initial mesh may be, as a variant, a meshed object which may be either the result of an earlier reconstruction or a file of CAD type.

A step 4 performs an X-ray tomography iterative reconstruction using a customary iterative algorithm (algebraic or probabilistic) but adapted to the representation with a non-regular mesh composed of triangles in 2D or respectively of tetrahedrons in 3D.

We consider the reconstruction volume composed of triangular elements in 2D reconstruction or tetrahedral elements in 3D reconstruction, whose associated unknown values correspond to the object that it is sought to reconstruct, and known projections of the object on the detector correspond to the measurements of each projection ray, and which are described in the form of a vector of dimension M=Nproj×Ndet, Nproj being the number of angle of projections from which the object is seen by the detector and Ndet the number of detector pixels imaging each projection.

The aim is to determine the object on the basis of the projections acquired, each of the values detected in a pixel of the detector being a linear combination of the values of the volume elements to be reconstructed.

By grouping the set of measurements together into a vector p and by representing the object to be reconstructed by the vector f, it is possible to model the transformation making it possible to pass from the object represented by the vector f to the observed data p, by a linear model of the form: p=Hf

H representing the projection matrix (or system matrix) whose coefficients hᵢⱼ represent the contribution of each element of the mesh to each projection ray. In the case of the proposed representation, these contributions correspond to the intersection length between a projection ray i and the element of the mesh Tⱼ (in the 2D case a mesh element corresponds to a triangle, in 3D to a tetrahedron).

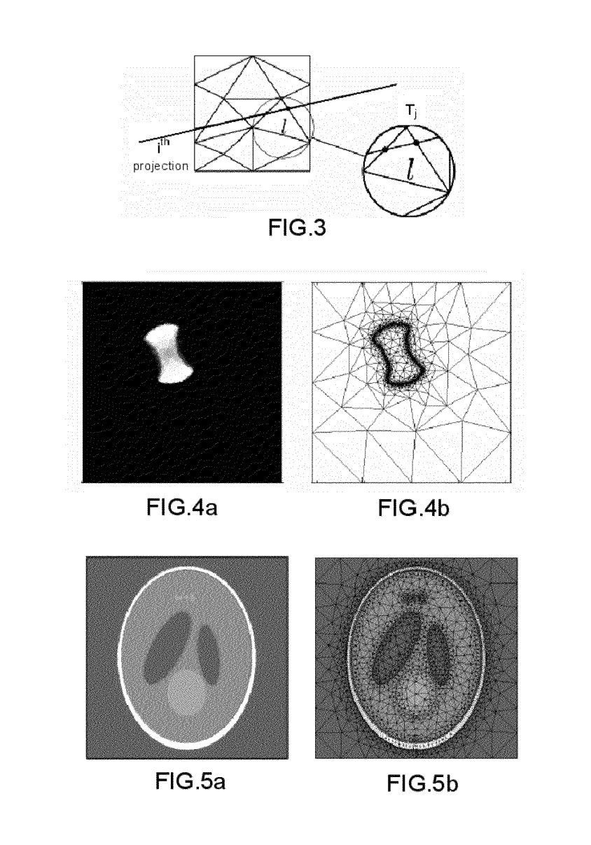

FIG. 3 is an illustration of this contribution in the 2D case of a mesh composed of triangles on which i^{th} projection represents the projection ray i, l represents the said intersection length, and Tⱼ represents the mesh element.

Numerous algorithms exist for solving this problem, that is to say for estimating f on the basis of its projections. In the present invention, use is made of an iterative algorithm customarily used within the framework of a conventional representation, respectively pixelized in 2D and voxelized in 3D, whose projection operator H is calculated by henceforth considering mesh elements, respectively triangular in 2D and tetrahedral in 3D, as indicated previously and illustrated in FIG. 3 for the 2D case.

As soon as the elements of the mesh match the content of the image, the elements of the matrix H are recalculated.

In 2D, the triangle structural element is composed of three vertices and of a face to which is assigned the value of the grey level or attenuation coefficient estimated by the tomography reconstruction algorithm.

In 3D, the tetrahedron structural element is composed of four vertices and of three faces to which are assigned the grey level value or attenuation coefficient estimated by the tomography reconstruction algorithm.

The segmentation step 1 is based on the results obtained in the previous step of iterative reconstruction 4. It consists in delimiting the contours of the various materials making up the object under study. The result of this step is thereafter used as constraint for adapting the elements of the mesh to the content of the image.

The assumption is made that each material making up the object under study is homogeneous, and use is made of the segmentation approach based on the Mumford-Shah model which segments an image by finding the best approximation of the image by a piecewise constant function.

Accordingly, use is made of the work of Chan and Vese [IEEE Trans. Im. Proc. (2001)10(2):266-277] proposing a simple and very efficient formulation of this model through a model of active contours without edges.

It then entails approximating the image by a function taking into account two values by means of the following optimization problem:

$${min}_{{c}_{1} {c}_{2} , C} F ( {c}_{1} , {c}_{2} ) = {min}_{{c}_{1} {c}_{2} , C} \{ {L}_{C} + μ {\int }_{{Ω}^{-}} {( {c}_{1} - f )}^{2} + μ {\int }_{{Ω}^{+}} {( {c}_{2} - f )}^{2} \}$$

in which:
C represents a curve for a two-dimensional image or a surface for a three-dimensional image, which represents the boundary between two constant regions (C=∂Ω);
c₁ and c₂ represent respectively the mean values of the piecewise constant regions for the interior Ω⁻ and for the exterior Ω⁻ of C;
L_{C} represents a regularization term making it possible to control the length of the curve C; and
μ represents a regularization term which controls the segmentation detail.

To solve the problem, a level sets representation is chosen:

C is replaced with a level set function φ(x),
Ω⁻ and Ω⁺ are defined by the Heaviside function ( [symbol] ).

The criterion to be minimized then becomes:

$$ɛ ( {c}_{1} {c}_{2} , ϕ ) v {\int }_{Ω} \vert ∇ ℋ ( ϕ ( x ) ) \vert d x + μ {\int }_{Ω} ℋ ( ϕ ( x ) ) {( {c}_{1} f ( x ) )}^{2} + ( 1 - ( ϕ ( x ) ) ) {( {c}_{2} - f ( x ) )}^{2} d x$$

in which Ω represents the segmentation domain, φ the level set function and ν represents the regularization term controlling the segmentation details.

The energy ε is then minimized by alternating estimation of the curve C in 2D and of the surface C in 3D, and updating of the values c₁ and c₂.

Thus, for fixed φ(x), it is possible to write the minimization of the energy ε with respect to the constants c1 and c2 as:

$${c}_{1} ( ϕ ( x ) ) = \frac{{\int }_{Ω}^{ } f ( x ) ( ϕ ( x ) ) d x}{{\int }_{Ω}^{ } 1 - ( ϕ ( x ) ) d x}$$

For fixed c₁ and c₂, the optimal curve C in 2D and of the optimal surface C in 3D can be estimated by using the following gradient flux which describes the Euler-Lagrange equation associated with the function φ(x) and which evolves in the direction normal to the curve C:

$$\frac{d ϕ}{d t} = {′}^{} ( ϕ ) ( ∇ \cdot \frac{∇ ϕ}{\vert ∇ ϕ \vert} - μ ( {( {c}_{1} - f )}^{2} + {( {c}_{2} - f )}^{2} ) )$$

In order to eliminate any difficulty related to the non-convex models and to circumvent the local minima, a global convex segmentation or GCS is performed, based on the observation that a stable solution of the previous gradient flux coincides with the stable state of the simplified flux:

$$\frac{d ϕ}{d t} = ( ∇ \cdot \frac{∇ ϕ}{\vert ∇ ϕ \vert} - μ ( {( {c}_{1} - f )}^{2} + {( {c}_{2} - f )}^{2} ) )$$

This simplified flux represents the gradient descent for minimizing the energy:

E(φ)=|∇φ|₁+μ [symbol] φ,r [symbol] ,

With r=(c₁−f)²−(c₂−f)²

This energy does not have a unique global minimum (as curves in 2D and surfaces in 3D do not have a unique representation by level set). In order to properly define the global minimum, the solution must be constrained in the interval [0; 1] thereby culminating in the following optimization problem:

$${min}_{0 \leq ϕ \leq 1} {\vert ∇ ϕ \vert}_{1} + μ 〈 ϕ , r 〉$$

The minimization is performed by using the Split Brigman approach defined by Goldstein et al. [J. Sci. Comput. (2010)45:272-293]. After minimization, the contour of the segmented region is found by thresholding the level set function such that:

C={x|φ(x)=α}

With xε [symbol] ² and αε]0,1[.

In the case of a single-material object, the image to be segmented is composed of two regions: the material and the background. The contour is then obtained by fixing

$$α = \frac{max \{ ϕ ( x ) \}}{2} .$$

In the case of a multi-material object, it is necessary to assign various values to α so as to segment the regions pairwise. The final segmentation S corresponds to the fusion of the set of curves obtained with the various values of α:

S=U_{iεI}^{C}^{ᵢ}

The values of α are fixed in such a way that they make it possible to segment the regions of low and of high attenuation coefficients. These values can be fixed by the user through his a priori knowledge of the object to be reconstructed, with the aid of histogram of the image by taking the values corresponding to the limits of the constant regions.

The segmentation step involving gradient calculations, it is necessary to pass to a customary representation of the image, that is to say a regular grid of pixels in 2D and of voxels in 3D.

The number of elements making up this volume is:

$$M = \frac{δ}{{l}_{m}} \cdot N$$

### With

N=Nₚ^{D} represents the number of pixels of a customary regular grid Gᵤ of pixels in 2D or respectively of voxels in 3D within the framework of tomographic reconstruction with Dε{2,3} the dimension of the volume to be reconstructed and Nₚ=max (Nₓ,N_{y}), Nₓ and N_{y} being the number of detector pixels along the dimensions of the detector
δ represents the spatial resolution of the regular grid Gᵤ
lₘ designates the mean length of the edges of the elements of the mesh

With each volume element of the regular grid is then associated the grey level value of the face of the volume element of the irregular grid whose barycentric coordinates minimize the Euclidian distance between the two volume elements of each of the two grids.

During step 2, the mesh is adapted to the content of the image. The adaptation of the mesh to the content of the image uses the segmentation obtained in the previous step. This segmentation may be composed of one contour or of several contours. So that the new mesh exhibits a fine mesh cell (i.e. small mesh elements in high density) at the level of the contours, becoming coarser as one moves further away therefrom (i.e. big mesh elements in low density), it is necessary to distribute a sufficient number of points homogeneously over each segmented contour. These points will constitute the initial set of points P on the basis of which the new mesh is generated. The set P constitutes a constraint on the generation of the new mesh, in the sense that the points of which it is composed are fixed.

The proposed criterion for calculating the optimal number of points Kᵢ for each contour Cᵢ is:
in the 2D case:

$${K}_{i} = k \cdot \frac{{L}_{{c}_{i}}}{{L}_{min}}$$

with:
L_{C}_{ᵢ} represents the length of the contour Cᵢ
Lₘᵢₙ=minᵢ{L_{c}_{ᵢ}} represents the minimum length of the lengths of all the contours Cᵢ
k is a constant whose value is fixed by the user, generally fixed at 100
in the 3D case:

$${K}_{i} = k \cdot \frac{{A}_{{c}_{i}}}{{A}_{min}}$$

with:
A_{C}_{ᵢ} represents the length of the contour Cᵢ
Aₘᵢₙ=minᵢ{A_{c}_{ᵢ}} represents the minimum area of the lengths of all the contours Cᵢ
k is a constant whose value is fixed by the user, generally fixed at 100

The Kᵢ points of each contour are thereafter distributed homogeneously in such a way that they are equidistant from one another.

The elements of the new mesh are created on the basis of the set of points P=U_{C}_{ᵢ}{pₖ}_{1, . . . , K}_{ᵢ}, for example with the aid of the “mesh generation” tool of the CGAL library, by considering two criteria: their shape and their size so as to generate a constrained Delaunay triangulation.

The shape criterion is taken into account by the quality criterion

$$B = \frac{r}{l} ,$$

r representing the radius of the circumscribed circle around the mesh element considered and l the length of the shortest edge of this same mesh element considered.

There exists a relation between B and the smallest angle βₘᵢₙ of the mesh element considered of the mesh element:

$$B = \frac{r}{l} = \frac{1}{2 \cdot sin ( {β}_{min} )}$$

from which the following relation is deduced:

$${β}_{min} = arcsin ( \frac{1}{2 B} )$$

Convergence of the algorithm is ensured for B≧\sqrt{2}, this corresponding to βₘᵢₙ=20.7°.
The size criterion is controlled by the parameter lₘₐₓ which defines the maximum length of the edges of the mesh element. The choice of lₘₐₓ plays a fundamental role in the creation of the mesh. Thus, so that the mesh cells are generated in such a way as to comply with the constraints and allow a progressively coarser mesh as one moves further away from the contours, the value of lₘₐₓ must satisfy the following condition:

$${1}_{max} >> \frac{{L}_{C}}{{K}_{C}}$$

where L_{C} is the length of the contour C, K_{C} the number of points describing the contour C.
The length of the contour is given by:

$${L}_{C} = {\sum }_{i = 0}^{{K}_{C}} ‖ {p}_{i + 1} - {p}_{i} ‖ where {p}_{i} ∈ P , i = \{ 0 , … , {K}_{C} - 1 \}$$

In the case where several contours are described by the set P, the optimal value lₒₚₜ is:

$${1}_{opt} >> \frac{ {L}_{{C}_{min}}}{{K}_{{C}_{min}}}$$

where L_{C}_{ₘᵢₙ} is the length of the shortest contour Cₘᵢₙ, K_{C}_{ₘᵢₙ} the number of points describing this smallest contour Cₘᵢₙ.

FIGS. 4a and 4b illustrate an implementation of the method for a two-dimensional image on the basis of experimental data with the proposed procedure. Here, this is a transverse section through a single-material object which is a steel drill 150 μm in diameter. FIG. 4a represents the grey level image, and FIG. 4b illustrates the corresponding irregular grid composed of a triangular mesh cell adapted to the content of the image depicting the final contour of the segmented object.

FIGS. 5a and 5b illustrate an implementation of the method for a two-dimensional image on the basis of numerical data with the proposed procedure. Here, this is a transverse section through a digital phantom or stated otherwise through a multi-material digitally defined object, called Shepp-Logan. FIG. 5a represents the reconstructed grey level image, and FIG. 5b illustrates the corresponding grid composed of a triangular mesh cell adapted to the content of the image (i.e. to the materials of which it is composed).

The steps of the above-described method can be carried out by one or more programmable processors executing a computer program to carry out the functions of the invention by acting on input data and by generating output data.

A computer program can be written in any programming language, such as compiled or interpreted languages, and the computer program can be deployed in any form, including in the guise of autonomous program or as a subprogram or function, or any other appropriate form for use in a computing environment.

A computer program can be deployed to be executed on a computer or on several computers on a single site or on several distributed sites linked together by a communication network.

1. An iterative method for determining a two-dimensional or three-dimensional image on the basis of signals arising from X-ray tomography, comprising:
segmenting the image by separating distinct materials respectively by level lines for a two-dimensional image or by level surfaces for a three-dimensional image, and
adapting the mesh, respectively triangular for a two-dimensional image or tetrahedral for a three-dimensional image, in which points are distributed respectively over a level line for a two-dimensional image or over a level surface for a three-dimensional image, serving to formulate the mesh, respectively triangular for a two-dimensional image or tetrahedral for a three-dimensional image, so that the number of distributed points depends respectively, for a line, on the ratio of the length of the line to the length of the minimum line from among the lines of the segmented image, or, for a surface, on the ratio of the area of the surface to the area of the minimum surface from among the surfaces of the segmented image.

2. The method according to claim 1, in which the number of distributed points to generate the adaptive mesh is respectively proportional, for a line, to the ratio of the length of the line to the length of the minimum line, or, for a surface, to the ratio of the area of the surface to the area of the minimum surface.

3. The method according to claim 1, in which the segmentation step uses an approximation of the image on the basis of a piecewise constant function.

4. The method according to claim 3, in which the approximation uses the following minimization:
$${min}_{{c}_{1} {c}_{2} , C} \{ {L}_{C} + μ {\int }_{{Ω}^{-}}^{ } {( {c}_{1} - f )}^{2} + μ {\int }_{{Ω}^{+}}^{ } {( {c}_{2} - f )}^{2} \}$$
in which:
C represents a curve for a two-dimensional image or a surface for a three-dimensional image, which represents the boundary between two constant regions (C=∂Ω);
c₁ and c₂ represent respectively the mean values of the piecewise constant regions for the interior Ω⁻ and for the exterior Ω⁻ of C;
L_{C} represents a regularization term making it possible to control the length of the curve C; and
μ represents a regularization term which controls the segmentation detail.

5. The method according to claim 1, further comprising initializing the mesh, with a mesh of constant elementary mesh cell complying with the Delaunay criterion.
